(19) United States
(12) Patent Application Publication
(10) Pub. No.: US 2006/0218240 A1
(43) Pub. Date: Sep. 28, 2006

(54) Music transmission controlling system and method

(75) Inventor: Hsin-Yuan Yang, Taipei (TW)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 11/088,851

(22) Filed: Mar. 25, 2005

(51) Int. Cl. G06F 15/16

(52) U.S. Cl. 709/217

(57) ABSTRACT

A music transmission controlling system and method is disclosed, in which at least one music file may be transmitted between a remote server device and an audio device via a wireless communication interface. In the music transmission controlling system, a detection device is used to detect the audio device, an audio storage device is used to store music files in the audio device, a computer storage device is used to store music files in the remote server device, a file comparing device is used to detect the music files stored in the computer storage device and the audio storage device and confirm different music files therebetween, and the remote server device transmits the different music files confirmed to the audio storage device.

### BACKGROUND OF THE INVENTION

1. Field of Invention

The present invention relates to a remote server device and an audio device and particularly to a music transmission controlling system and method where at least one music file may be transmitted between a server device and an audio device.

2. Related Art

As generally known, music is an indispensable part of human's life. Particularly, music is often brought to enhance cozy and wonderful atmosphere in some occasions, such as social contacts, small get-togethers and private rooms.

Referring to FIG. 1, a schematic illustration of music playing of a prior audio device is provided therein. In the prior audio device 2, music is typically pre-stored in a music storage medium 10, such as record tapes and optical discs. When the music storage medium 10 is coupled with the audio device 2, a reading device 4 of the audio device 2 may read the music stored in the music storage medium 10 and a playing device 6 may then plays the music by using a loudspeaker 12 to audience 8.

With the advent of medium and digital times, digitalized music files have been widely developed and utilized, which may facilitate transmission and copying of music files. MP3 music files are examples based on the digitalized music technology. Since these digitalized music files are convenient to be transmitted and copied, they have been widely spread in our daily life.

With respect to the audio devices 2 used in vehicles (referred to hereinafter as “vehicle audio devices”), record tapes, optical discs and the like which are easy to be carried are generally used as the music storage medium 10. In this case, the drivers and the passengers may not enjoy a great deal of different and ever-changing music. Moreover, the record tapes and the optical discs are required to be carried in and out of the vehicles providing a various of different music is desired and which seems to be quite troublesome for a user thereof.

Therefore, there is a need to provide a music transmission controlling system and method stored in an audio device and a remote server device.

### SUMMARY OF THE INVENTION

It is, therefore, an object of the present invention to provide a music transmission controlling system and method to update music files stored in a vehicle audio device in a rapid, convenient and automatized manner so that a driver and passengers of the vehicle may enjoy a great deal of ever-updated music.

To achieve the above mentioned object, the music transmission controlling system in accordance with the present invention may control at least one music file transmitted between a remote server device and an audio device, in which the music file comprises information associated with a singer thereof, information associated with an album corresponding thereto and information associated with song content corresponding thereto. The music transmission controlling system is located on the remote server device, and comprises a wireless communication interface, a transmission setting module, a detection device, a computer storage device and a file comparing device. The audio device comprises a self-timer, a mode control module, and an audio storage device.

The wireless communication interface is communicatively connected to the audio device and the remote server device. The mode control module presets a control mode of the audio device, wherein the control mode may be a music file updating control mode, a music file adding control mode, a music file fixing control mode and the like.

The transmission setting module presets the transmission mode comprising a transmission amount and a selection manner, in which the transmission amount is a number representing a quantity of music files to be transmitted and the selection manner may be random selection, singer-based selection, album-based selection manners and the like.

The detection device is disposed in the remote server device and detects the audio device via the wireless communication interface. Also, the detection device detects a control mode prescribed by the audio device.

The audio storage device is located in the audio device and stores music files in the audio device. The computer storage device is located in the remote server device and stores music files stored in the remote server device.

The file comparing device is disposed in the remote server device and connected to the computer storage device. When the audio device is detected by the detection device, the detection device detects the music files stored in the computer storage device and detects the music files stored in the audio storage device via the wireless communication interface to confirm different music files between the computer storage device and the audio storage device.

When a predetermined time clocked by the self-timer, the remote server device transmits the different music files between the computer storage device and the audio storage device via the wireless communication interface from the computer storage device to the audio storage device in the predetermined transmission mode. Whereby, the remote server updates and makes the music files stored in the audio device identical to the music files stored in the audio device.

Therefore, with the music transmission controlling system and method transmitted between the remote server device and the vehicle audio device, the music files stored in the vehicle audio device may be updated in a rapid, convenient and automatized manner by virtue of digitalization and wireless communication techniques so that a driver and passengers of the vehicle may enjoy a great deal of different music which may be updated forever.

The advantages and spirits of the present invention may be further understood after the detailed description as follows is read in connection with the attached drawings.

### BRIEF DESCRIPTION OF THE DRAWINGS

The invention will become more fully understood from the detailed description given hereinbelow illustration only, and thus are not limitative of the present invention, and wherein:

FIG. 1 is a schematic illustration of music playing of a prior audio device;

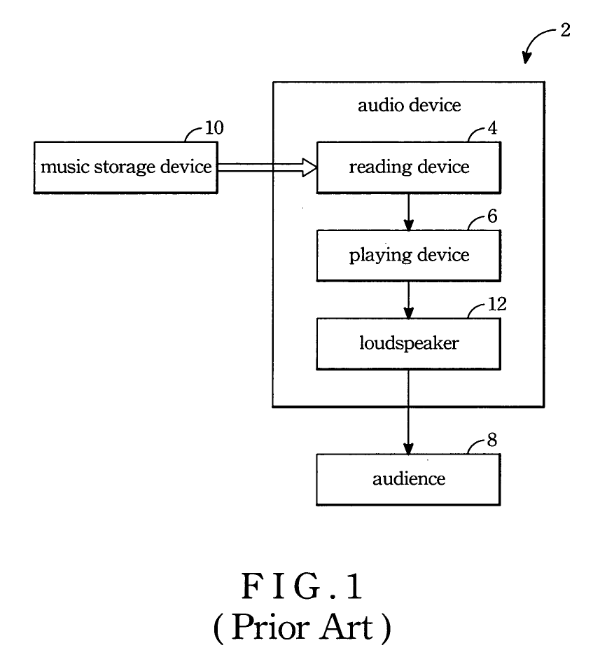

FIG. 2 is a schematic illustration of a music transmission controlling system according to the present invention; and

FIG. 3 is a flowchart of a music transmission controlling method according to the present invention.

### DETAILED DESCRIPTION OF THE INVENTION

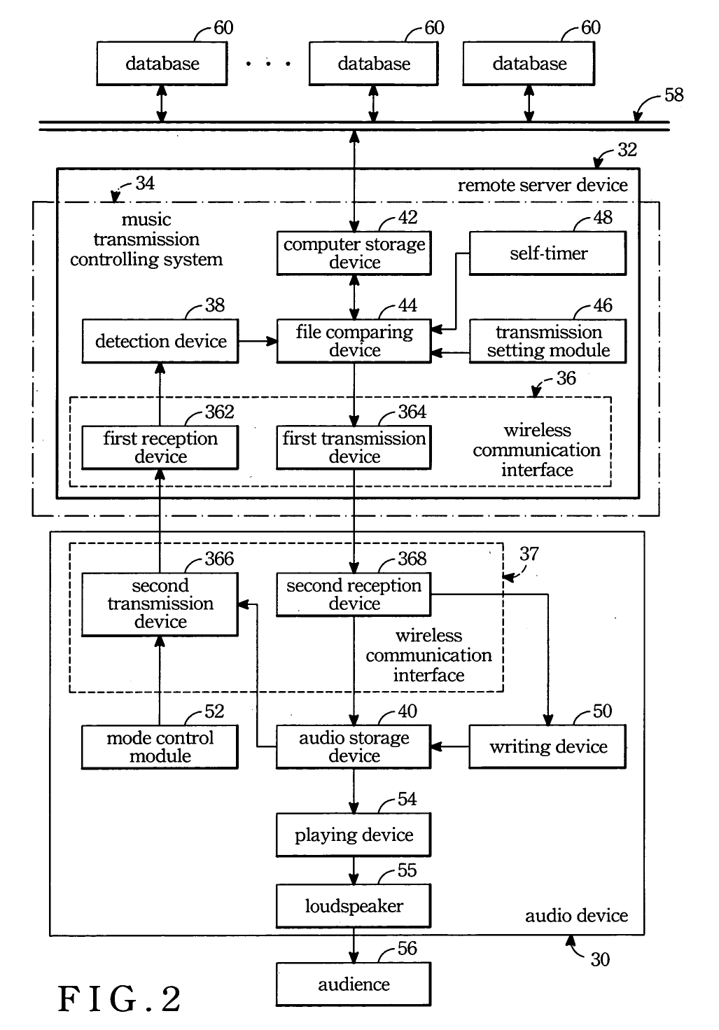

Referring to FIG. 2, a schematic illustration of an embodiment of a music transmission controlling system according to the present invention is provided therein. The music transmission controlling system 34 is located in a remote server device 32, to transmit at least one music file between the remote server device 32 and an audio device 30. The audio device may be a vehicle audio device. The music file comprises information associated with a singer thereof, information associated with an album corresponding thereto and information associated with song content corresponding thereto. In the music transmission controlling system 34, there comprise a wireless communication interface 36, a self-timer 48, a transmission setting module 46, a detection device 38, a computer storage device 42 and a file comparing device 44. The audio device comprises a mode control module 52, an audio storage device 40, and a writing device 50.

The wireless communication interface 36 of the remote server device 32 is communicatively connected to a wireless communication interface 37 of the audio device 30. The remote server device 32 comprises a first reception device 362 and a first transmission device 364. The audio device 30 comprises a second reception device 368 and a second transmission device 366. The wireless communication interface may be a short-distance wireless communication module in compliance with the IEEE 802.11 protocol or the bluetooth protocol.

The mode control module 52 is located in the audio device 30 and used to preset a control mode of the audio device 30. The mode control module 52 comprises a music file updating control mode, a music file adding control mode, a music file fixing control mode and the like. The music file updating control mode is specified for updating all music files stored in the audio storage device 40. The music file adding control mode is specified for adding desired music files into the audio storage device 40. The music file fixing control mode is specified for maintaining the music files stored in the audio storage device 40 under any condition.

The transmission setting module 46 is located in the remote server device 32 and used to preset a transmission mode. The transmission mode comprises a transmission amount and a selection manner. The transmission amount is a number and the number representing an amount of music files predetermined to be transmitted. Specifically, the transmission amount is defined as a quantity of the music files predetermined to be transmitted to the audio device 30 from the remote server device 32. The selection manner may be random selection, singer-based selection, song title-based selection, album-based selection and the like. The random selection means that the music files desired to be transmitted to the audio device 30 from the remote server device 32 are selected at a random. The singer-based selection means that the music files desired to be transmitted are selected with respect to singers corresponding thereto. The song title-based selection means that the music files desired to be transmitted are selected with respect to song titles corresponding thereto. The album-based selection means that the music files desired to be transmitted are selected with respect to albums corresponding thereto. It is to be noted that the above mentioned selected manners may be used individually or as a combination.

The detection device 38 is disposed in the remote server device 32 and used to detect the audio device 30 via the wireless communication interface 36 [symbol] 37. Specifically, a wireless signal is transmitted through a second transmission device 366 of the audio device 30 and a first reception device 362 of the remote server device 32 is used to receive the wireless signal. In this way, it may be confirmed if the audio device 30 be located within a range so that the audio device 30 may be communicated via a wireless short-distance communication module. In addition, the detection device 38 detects a control mode prescribed by the audio device 30.

The audio storage device 40 and the computer storage device 42 are located in the audio storage device 30 and the remote server device 32, respectively, and the audio storage device 40 and the computer storage device 42 may both take a form of a hard disc drive. The hard disc drive-formed audio storage device 40 may further be in the form of a removable portable device to facilitate a maintenance and replacement task thereof.

The audio storage device 40 is located in the audio device 30 and used to store the music files transmitted from the first transmission device 364 and received by the second reception device 368 by means of a writing device 50. The computer storage device 42 is located in the remote server device 32 and used to store the music files in the remote server device 32.

The file comparing device 44 is disposed in the remote server device 32 and connected to the computer storage device 42. When the audio device 30 is detected by the detection device 38, the file comparing device 44 is used to detect the music files in the computer storage device 42 and detect the music files in the audio storage device 40 through a first transmission device 364 and a second reception device 368 of the wireless communication interface 37. The music files in the computer storage device 42 and the computer storage device 42 are compared and different music files therebetween are confirmed.

When a predetermined time is clocked by the self-timer 48 in the remote server device 32, the different music files between the remote server device 32 and the computer storage device 42 are transmitted from the computer storage device 42 to the second reception device 368 via the first transmission device 464 via the wireless communication interface 36 [symbol] 37 in a predetermined control mode and a predetermined transmission mode. Then, the music files received by the second reception device 368 are transmitted to the audio storage device 40 for storage. As such, the music files stored in the audio storage device 40 may be played by the playing device 54 through a loudspeaker 55 to the audience 56.

Further, in the music transmission controlling system 34 the remote server device 32 is coupled through the Internet 58 to at least one database 60 so that the music files stored in the database 60 may be loaded into the computer storage device 42.

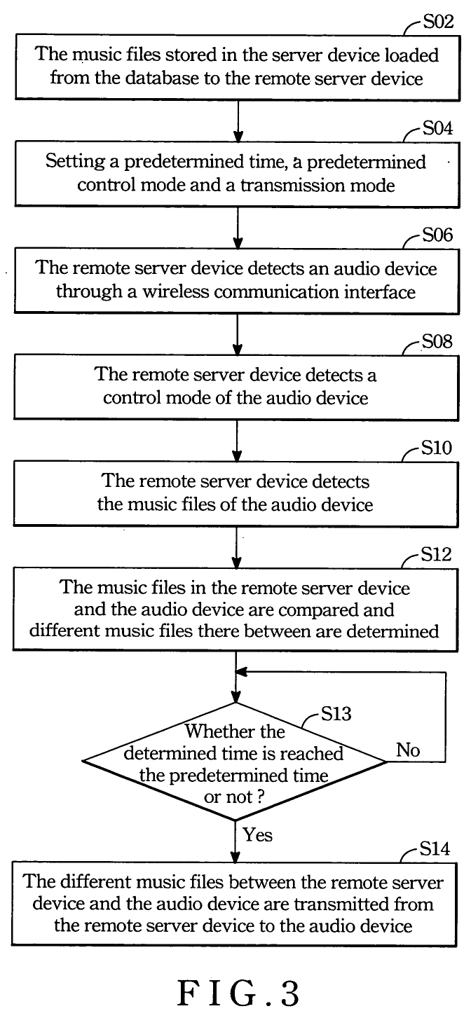

Referring to FIG. 3, a flowchart of a music transmission controlling method according to the present invention is illustrated therein, in which at least one music file is transmitted between the remote server device 32 and the audio device 30. The audio device 30 may be, for example, a vehicle audio device. The music file as mentioned in the context herein comprises information associated with a singer thereof, the song title thereof, the album corresponding thereto, the song content corresponding thereto and the like.

The music transmission controlling method according to the present invention comprises the steps of:

S02: The server device 32 is coupled through the Internet 58 to at least one database 60. From the database 60, the music files stored in the server device 32 may be loaded to the remote server device 32.

S04: Setting a predetermined time, a predetermined control mode and a transmission mode. The control mode may be a music file updating control mode, a music file adding control mode, a music file fixing control mode and the like. The transmission mode comprises a transmission amount and a selection manner, in which the transmission amount is a number representing a quantity of the music files to be transmitted and the selection manner may be a random selection, a singer-based selection, a song title-based, an album-based selection manners and the like.

S06: The remote server device 32 detects an audio device 30 via a wireless communication interface 36 [symbol] 37, which may be any kind of wireless short-distance communication module in compliance with the IEEE 802.11 protocol or the bluetooth protocol.

S08: The remote server device 32 detects a control mode of the audio device 30 via the wireless communication interface 36 [symbol] 37.

S10: The remote server device 32 detects the music files stored in the remote server device 32 and detects the music files stored in the audio device 30 via the wireless communication interface 36 [symbol] 37.

S12: The music files in the remote server device 32 and the audio device 30 are compared and different music files therebetween are determined.

S13: Whether the determined time is reached the predetermined time or not?

S14: At the determined time, the different music files between the remote server device 32 and the audio device 30 as determined in S12 are transmitted from the remote server device 32 to the audio device 30 in a predetermined control mode and a transmission mode, and stored in a hard disc drive of the audio device 30, wherein the hard disc drive may be in the form of a removable portable drive.

Through the music transmission controlling system and methodmusic transmission controlling system between the remote server device 32 and the audio device 30 according to the present invention, the music files stored in the remote server device 32 may be loaded into the vehicle audio device 30 and the music files in the vehicle audio device 30 may be updated in a rapid, convenient and automatized manner so that a driver and passengers of the vehicle may enjoy a great deal of different and ever-updated music.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. A music transmission controlling system located in a remote server device and used to transmit at least one music file between a remote server device and an audio device, comprising:
a wireless communication interface communicatively connected to the audio device and the remote server device;
a detection device disposed in the remote server device and detecting the audio device via the wireless communication interface;
a computer storage device located in the remote server device and storing music files; and
a file comparing device detecting and comparing the difference between the music files stored in the computer storage device and the music files stored in the audio device via the wireless communication interface when the audio device is detected by the detection device to confirm different music files between the computer storage device and the audio storage device;
wherein the remote server device transmits the different music files between the computer storage device and the audio device to update and make the music files stored in the audio device identical to the music files stored in the audio device.

2. The music transmission controlling system as recited in claim 1, wherein the audio device further comprises an audio storage device used for storing the music files in the audio device.

3. The music transmission controlling system as recited in claim 1, wherein the detection device further detects a control mode prescribed by the audio device, and the control mode is prescribed by a mode control module and selected from a group consisting of a music file updating control mode, a music file adding control mode and a music file fixing control mode.

4. The music transmission controlling system as recited in claim 2, wherein the remote server device transmits the music file to the audio storage device in compliance with a predetermined transmission mode and the transmission mode is prescribed by a transmission setting module and comprises a transmission amount and a selection manner.

5. The music transmission controlling system as recited in claim 4, wherein the music file is selected from the group consisting of information associated with a singer thereof, information associated with a song title thereof, information associated with an album corresponding thereto and information associated with song content thereof.

6. The music transmission controlling system as recited in claim 5, wherein the transmission amount is a number and the number is a quantity of the music files to be transmitted prescribed by a user through the transmission setting module and wherein the selection manner is selected from a group consisting of a random selection, a song title-based selection, a singer-based selection and an album-based selection manners.

7. The music transmission controlling system as recited in claim 2, wherein the computer storage device and the audio storage device are a hard disc drive.

8. The music transmission controlling system as recited in claim 7, wherein the hard disc drive is removable.

9. The music transmission controlling system as recited in claim 1, wherein the audio device is a vehicle audio device.

10. The music transmission controlling system as recited in claim 1, wherein the wireless communication interface is a short-distance wireless communication module.

11. The music transmission controlling system as recited in claim 1, wherein the remote server device is coupled to at least one database through the Internet and loads the music file from the database to the computer storage device.

12. The music transmission controlling system as recited in claim 2 further comprising a self-timer, when the time calculated by the self-timer fits in with a predetermined time, the file comparing device transmits the different music files between the computer storage device and the audio storage device to the audio storage device via the wireless communication interface.

13. A music transmission controlling method used to transmit of at least one music file between a remote server device and an audio device, comprising the steps of:
detecting the audio device by the remote server device via a wireless communication interface;
detecting music files stored in the audio device via the wireless communication interface by the remote server device;
comparing the music files in the remote server device and the music files in the audio device to obtain different music files therebetween; and
transmitting the different music files between the remote server device and the audio device from the remote server device to the audio device.

14. The music transmission controlling method as recited in claim 13, further comprising the steps of: detecting a control mode prescribed by the audio device, wherein the control mode is selected from a group consisting of a music file updating control mode, a music file adding control mode and a music file fixing control mode.

15. The music transmission controlling method as recited in claim 13, further comprising a step of transmitting the music file to the audio storage device by the remote server device in compliance with a predetermined transmission mode wherein the transmission mode comprises a transmission amount and a selection manner.

16. The music transmission controlling method as recited in claim 15, wherein the music file is selected from the group consisting of information associated with a singer thereof, information associated with a song title thereof, information associated with an album corresponding thereto and information associated with song content thereof.

17. The music transmission controlling method as recited in claim 16, wherein the transmission amount is a number and the number is a quantity of the music files to be transmitted prescribed by a user through the transmission setting module and wherein the selection manner is selected from a group consisting of a random selection, a song title-based selection, a singer-based selection and an album-based selection manners.

18. The music transmission controlling method as recited in claim 13, wherein the music files are stored in the audio device at a hard disc drive thereof.

19. The music transmission controlling method as recited in claim 18, wherein the hard disc drive is removable.

20. The music transmission controlling method as recited in claim 13, wherein the audio device is a vehicle audio device.

21. The music transmission controlling method as recited in claim 13, wherein the wireless communication interface is a short-distance wireless communication module.

22. The music transmission controlling method as recited in claim 13, wherein the remote server device is coupled to at least one database through the Internet and loads the music file from the database to the computer storage device.

23. The music transmission controlling method as recited in claim 13, further comprising a self-timer, when the time calculated by the self-timer fits in with a predetermined time, transmitting the different music files between the computer storage device and the audio storage device to the audio storage device via the wireless communication interface.
